(19) United States
(12) Patent Application Publication
(10) Pub. No.: US 2014/0074962 A1
(43) Pub. Date: Mar. 13, 2014

(54) BROWSER DEVICE, BROWSER PROGRAM, BROWSER SYSTEM, IMAGE FORMING APPARATUS, AND NON-TRANSITORY STORAGE MEDIUM

(71) Applicant: Konica Minolta Inc., Chiyoda-ku (JP)

(72) Inventor: Takahiro KANO, Toyonaka-shi (JP)

(73) Assignee: Konica Minolta Inc., Chiyoda-ku (JP)

(21) Appl. No.: 14/024,775

(22) Filed: Sep. 12, 2013

(30) Foreign Application Priority Data
Sep. 13, 2012 (JP) 2012-201599

(51) Int. Cl. H04L 29/08

(52) U.S. Cl. CPC H04L 67/2842
USPC 709/213

(57) ABSTRACT

Browser device for obtaining web data of specified URL. Browser device includes: registration unit configured to register one or more URLs; dedicated cache memory configured to, when first web data is obtained from registered URLs, store first web data without deleting existing web data that is stored already therein; general-purpose cache memory configured to, when second web data is obtained from unregistered URL, delete part or all of existing web data that is stored already therein, in accordance with capacity of general-purpose cache memory, an amount of existing web data, and amount of second web data, and then store second web data; and obtaining unit configured to, when web data of specified URL is stored in one of dedicated cache memory and general-purpose cache memory, obtain web data therefrom. URLs registered by registration unit are in range that allows for storage of web data in dedicated cache memory.

### CROSS-REFERENCE TO RELATED APPLICATIONS

This application is based on application No. 2012-201599 filed in Japan, the contents of which are hereby incorporated by reference.

### BACKGROUND OF THE INVENTION

(1) Field of the Invention

The present invention relates to a browser device, a browser program, a browser system, and an image forming apparatus, in particular to a technology for reducing the time required for obtaining web data.

(2) Description of the Related Art

In recent years, purchasing application programs via the Internet has become popular. In the field of image forming apparatus too, providing application programs via a network by a so-called third party has started to be in practical use. It is expected that this will enable various applications such as an image data management program and an image processing program to be provided at lower prices, enhancing the user-friendliness of the image forming apparatuses.

The widespread use of browser programs in these days taken into account, the most efficient way to provide application programs via a network would be to do it with use of a browser program.

In general, an application program has a large amount of data, and transmission/reception thereof via a network would take time. In particular, with regard to an image forming apparatus, a broadband communication environment is not necessarily be ensured, and thus it may take time for the image forming apparatus to transmit or receive an application program. Accordingly, if an image forming apparatus transmits a request for the web server to transmit an application program each time the application program is used, it must always wait for a long time before the application program is activated.

In general, to reduce the wait time for obtaining the web data, the cache memory is used. However, since the cache memory is typically managed by an LRU (Least Recently Used) algorithm, even after an application program is stored in the cache memory, a reception of another web data may cause the application program to be deleted from the cache memory. Thus the wait time for obtaining an application program cannot be reduced with certainty.

As another problem, since image forming apparatuses have tight cost constraints compared with personal computers or the like, it is difficult to increase the cache memory in size. For this reason, cache data is often deleted, and the activation time tends to be long.

Among some technologies proposed to solve the above-described problems, there is, for example, a technology that assigns priorities to a plurality of pieces of web data stored in the cache memory such that the higher the frequency of obtaining a piece of web data is, the higher the priority of the piece of web data is, and pieces of web data with lowest priorities are deleted from the cache memory (see Japanese Patent Application Publication No. 2009-110216). With the structure of this conventional technology, an application program is assigned a high priority if it is often used, and an application program with a high priority is difficult to be deleted. This makes it possible to reduce the wait time for activating the application program with high frequency.

However, the above-described conventional technology can only makes it difficult for an application program with a high priority to be deleted from the cache memory, but cannot completely prevent the application program from being deleted from the cache memory. For example, if web data other than the application program is obtained to such an extent that the cache memory becomes full, the application program is, of course, deleted from the cache memory, and it takes time for the application program to be activated next time. Here, deletion of data from the cache memory is referred to as a “cache-out”. As described above, in general, when a cache-out of web data occurs, the time required to obtain the web data for use is extended.

Accordingly, a technology for preventing the time required to obtain web data from being extended due to a cache-out is sought after.

### SUMMARY OF THE INVENTION

It is therefore an object of the present invention to provide a browser device, a browser program, a browser system, and an image forming apparatus that can prevent the time required to obtain web data from being extended due to a cache-out.

The above object is fulfilled by a browser device for obtaining web data of a specified URL, the browser device comprising: a registration unit configured to register one or more URLs; a dedicated cache memory configured to, when first web data is obtained from one of the one or more URLs registered, store the first web data without deleting existing web data that is stored already therein; a general-purpose cache memory configured to, when second web data is obtained from un unregistered URL, delete part or all of existing web data that is stored already in the general-purpose cache memory, in accordance with a capacity of the general-purpose cache memory, an amount of the existing web data that is stored already in the general-purpose cache memory, and an amount of the second web data, and then store the second web data; and an obtaining unit configured to, when the web data of the specified URL is stored in one of the dedicated cache memory and the general-purpose cache memory, obtain the web data therefrom, wherein the one or more URLs registered by the registration unit are in a range that allows for storage of web data in the dedicated cache memory.

### BRIEF DESCRIPTION OF THE DRAWINGS

These and the other objects, advantages and features of the invention will become apparent from the following description thereof taken in conjunction with the accompanying drawings which illustrate a specific embodiment of the invention. In the drawings:

FIG. 1 illustrates the structure of the browser system in the embodiment of the present invention;

FIG. 2 illustrates the structure of the MFP 100 included in the browser system 1;

FIG. 3 illustrates the hardware structure of the controller 200 included in the MFP 100;

FIG. 4 illustrates the software structure of the controller 200;

FIG. 5 is a flowchart illustrating the main dispatch process of the operating system 410;

FIG. 6 illustrates the hardware structure of the application server 102 included in the browser system 1;

FIG. 7 illustrates the software structure of the application server 102;

FIG. 8 is a sequence diagram illustrating the operation for registering an application program with the MFP 100;

FIG. 9 is a flowchart illustrating the operation of the application management program 700;

FIG. 10 is a flowchart illustrating the operation of the API program 401;

FIG. 11A illustrates the browser screen displayed on the operation panel 201;

FIG. 11B illustrates the application screen displayed on the operation panel 201;

FIG. 12 is a sequence diagram illustrating the operation for the registered application program 404 to be activated by the user of the MFP 100;

FIG. 13 is a flowchart illustrating the operation of the browser program 400 for activating the application program 404;

FIG. 14 is a diagram illustrating the data structure managed by the browser program 400;

FIG. 15 is a flowchart illustrating the process of registering a web page with the favorites;

FIG. 16 is a flowchart illustrating the process of displaying a web page registered with the favorites;

FIG. 17 is a diagram illustrating the data structure of the general-purpose cache storage area managed by the browser program 400; and

FIG. 18 is a flowchart illustrating the main operation of the browser program 400 in a modification of the present invention.

### DESCRIPTION OF EMBODIMENTS

The following describes an embodiment of a browser device, a browser program, a browser system, and an image forming apparatus of the present invention, with reference to the accompanying drawings.

### [1] STRUCTURE OF BROWSER SYSTEM

First the structure of the browser system in the embodiment of the present invention is described.

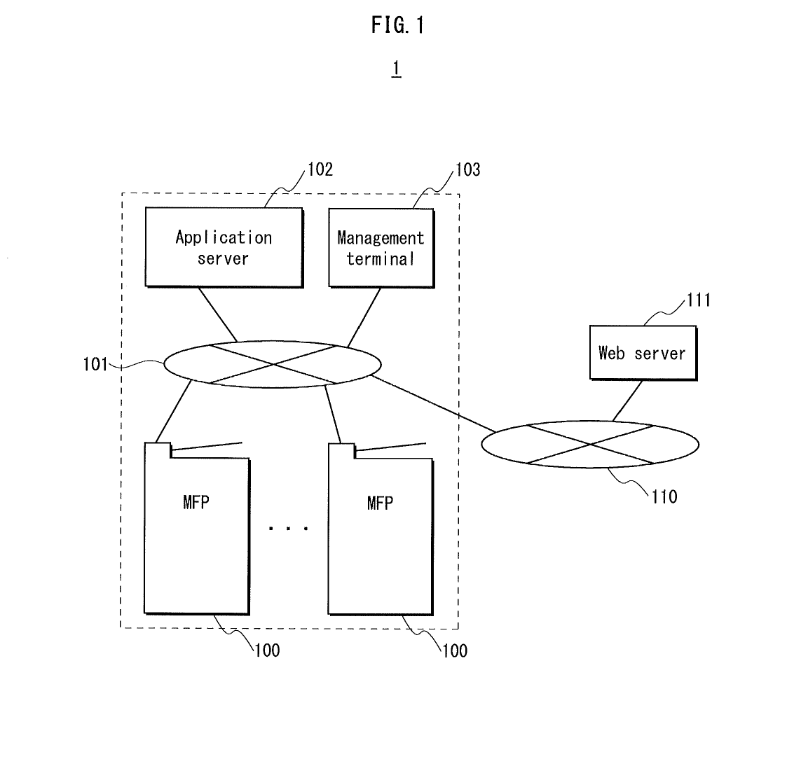

FIG. 1 is a diagram illustrating the main structure of the browser system in the embodiment of the present invention. As illustrated in FIG. 1, a browser system 1 has a structure where MFPs (Multi-Function Peripherals) 100 are connected with an application server 102 and a management terminal 103 via a LAN (Local Area Network) 101. The LAN 101 is connected with the Internet 110 as well.

The MFP 100, loaded with the browser program, can function as a browser device that obtains web data from a web server 111 via the LAN 101 and Internet 110. The management terminal 103 manages the operation of the MFP 100. More specifically, the management terminal 103 monitors the number of prints, remaining amount of toner, occurrence of a malfunction and the like in each MFP 100, and, as explained below, instructs the application server 102 to access the MFP 100.

The application server 102, upon receiving an instruction from the management terminal 103 as described below, registers, in the MFP 100, an application program as web data. The user of the MFP 100 uses the registered application program by activating it by using the browser program. This structure realizes various use forms of the MFP 100, improving the user-friendliness.

### [2] STRUCTURE OF MFP 100

Next, the structure of the MFP 100 is explained.

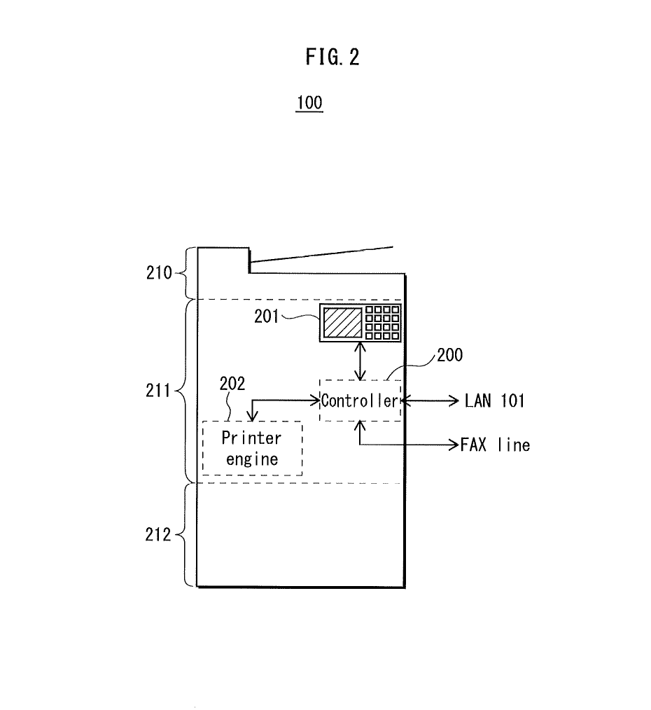

The MFP 100 is an image forming apparatus having the functions of a printer, scanner, and facsimile machine. As illustrated in FIG. 2, the MFP 100 includes a scanner 210, a printer 211, and a paper feeder 212. The scanner 210, provided with an ADF (Automatic Document Feeder), feeds a plurality of documents one by one and generates image data by reading each of the documents.

The printer 211 includes a controller 200, an operation panel 201, and a printer engine 202. The controller 200 receives image data from the scanner 210, and transmits and receives image data to/from other devices such as a PC (Personal Computer) and a facsimile machine via the LAN 101 or a facsimile line. Based on the image data obtained as above, the printer engine 202 forms a toner image on a recording sheet fed by the paper feeder 212, under the control of the controller 200.

The controller 200 may receive an instruction from the user via the operation panel 201, and display information for the user. In particular, the controller 200 may execute the browser program to display web data that is obtained from a user-specified URL, or execute an application program.

### [3] STRUCTURE OF CONTROLLER 200

The following describes the structure of the controller 200, first the hardware structure, and then the software structure.

(3-1) Hardware Structure of Controller 200

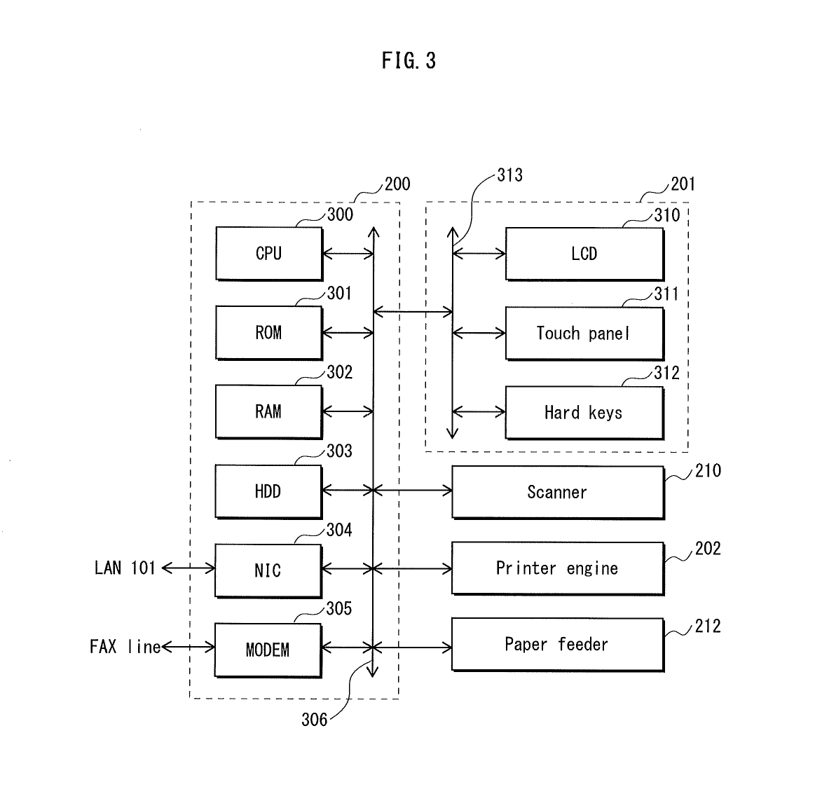

FIG. 3 is a diagram illustrating the main hardware structure of the controller 200. As illustrated in FIG. 3, the controller 200 includes a CPU (Central Processing Unit) 300, a ROM (Read Only Memory) 301, a RAM (Random Access Memory) 302, an HDD (Hard Disk Drive) 303, an NIC (Network Interface Card) 304, and a facsimile modem 305, which are interconnected with each other via an internal bus 306. When powered on, the CPU 300 reads a boot program from the ROM 301 and performs a boot-up operation, then reads from the HDD 303 programs such as an OS (Operating System) and the browser program, and operates by using the RAM 302 as a working storage area. The ROM 301 is a nonvolatile memory. The RAM 302 may be a volatile memory.

The NIC 304 is provided to perform communications with other devices via the LAN 101 or the Internet 110 under the control of the CPU 300, and executes, for example, the protocol processing of lower four layers in the OSI (Open Systems Interconnection) reference model. The facsimile modem 305 performs facsimile communications with other devices via the facsimile line under the control of the CPU 300, wherein received facsimile data is printed by the printer engine 202.

The operation panel 201 includes an LCD (Liquid Crystal Display) 310, a touch panel 311, and hard keys 312. The LCD 310, touch panel 311, and hard keys 312 are connected with the internal bus 306 of the controller 200 via a local bus 313. The operation panel 201 displays information for the user on the LCD 310 under the control of the controller 200. Also, the touch panel 311 is provided on the surface of the LCD 310. The touch panel 311 and the liquid crystal display operate in conjunction with each other to receive an instruction input by the user. The operation panel 201 receives an instruction input by the user via the hard keys 312 as well, and outputs an input signal corresponding to the received instruction to the controller 200.

The internal bus 306 of the controller 200 also connects to the scanner 210, printer engine 202, and paper feeder 212 such that they operate under the control of the controller 200.

(3-2) Software Structure of Controller 200

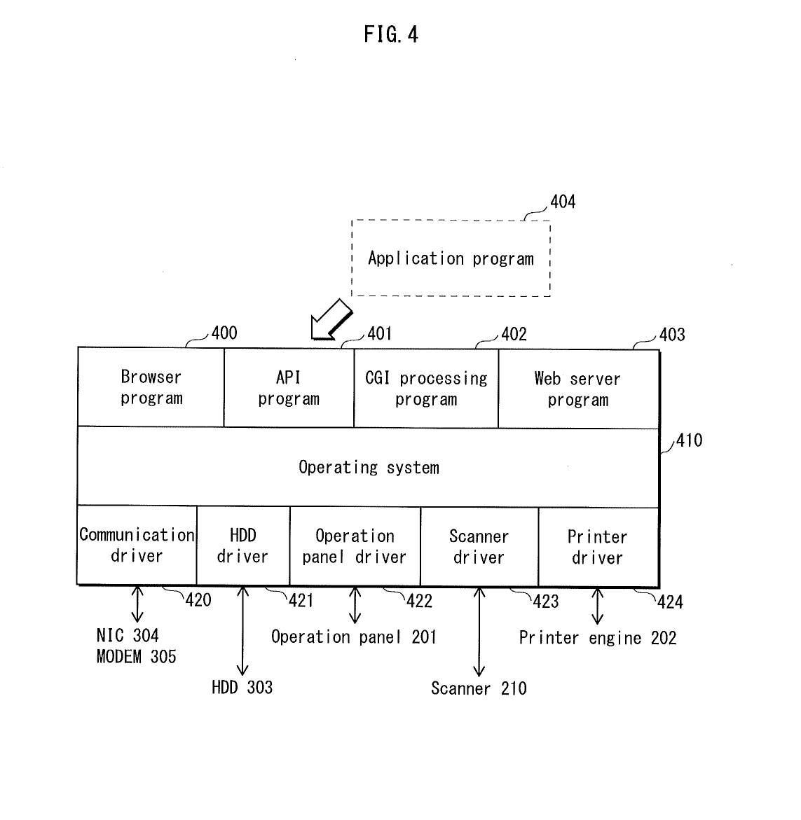

FIG. 4 is a diagram illustrating the main software structure of the controller 200. As illustrated in FIG. 4, the controller 200 is loaded with an operating system 410 (for example, Linux (registered trademark of Mr. Linus Torvalds)). A browser program 400, an API (Application Program Interface) program 401, a CGI (Common Gateway Interface) processing program 402, a web server program 403 and the like are executed on the operating system 410. The browser program 400 obtains web data from a location specified by a URL (Universal Resource Locator), and performs a display or execution by using the obtained web data.

(3-2-1) Operating System 410

The operating system 410 includes a communication driver 420, an HDD driver 421, an operation panel driver 422, a scanner driver 423, a printer driver 424 and the like that are embedded therein as device drivers. The operating system 410 manages the execution of programs. More specifically, for example, upon receiving an input from the device driver, the operating system 410 assigns the process to the browser program 400, API program 401 or the like (dispatch process). Also, the operating system 410 passes an output from the browser program 400 or the like to a corresponding device driver.

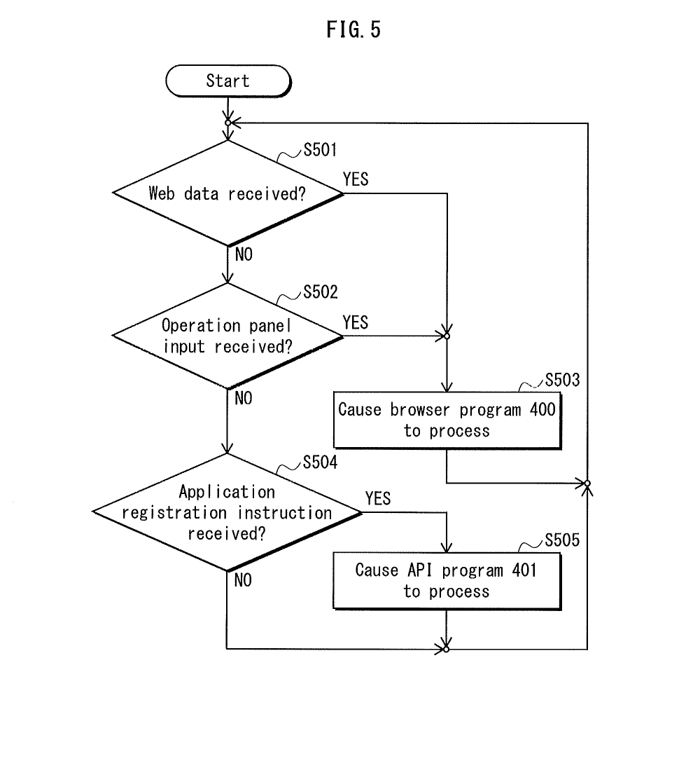

FIG. 5 is a flowchart illustrating the main dispatch process of the operating system 410. As illustrated in FIG. 5, when the communication driver 420 receives web data from the web server 111 (S501: YES), or when the operation panel driver 422 receives an instruction to activate an application program (this instruction is described below), from the user of the MFP 100 via the operation panel 201, or an instruction to display a web page (S502: YES), the operating system 410 causes the browser program 400 to process the received instruction (S503).

Also, when the communication driver 420 receives an application registration instruction (described below) from the application server 102 (S504: YES), the operating system 410 causes the API program 401 to process the application registration instruction (S505). After the browser program 400 or the API program 401 completes the processing, the control returns to step S501 and the above-described processes are repeated. Note that, when an event other than the above-described instructions, such as an input, occurs, the operating system 410 causes a corresponding program to process the event.

(3-2-1) Browser Program 400

The browser program 400, as is the case with a general browser program, receives specification of a web page from the user via the operation panel 201, and displays the specified web page on the display, or registers it with the favorites. Also, as described below, the browser program 400 may be used to activate an application program stored in a dedicated cache storage area.

(3-2-2) API Program 401

The API program 401 is a program that allows for other devices to use the MPF 100 via a network and realizes various functions. The API program 401, for example, may cause the MPF 100 to print image data stored in another device upon receiving specification of the image data from the other device, or may cause the MPF 100 to transfer image data, which is generated by the MPF 100 by scanning, to another device. In particular, the API program 401 receives a supply of the application program 404 from the application server 102, and let the user use the application program 404, with the browser program 400 being run as the user interface. In this case, the application program 404 may be executed with use of the CGI processing program 402.

(3-2-3) CCI Processing Program 402

The CGI processing program 402 executes a CGI program in accordance with a request received from the web server program 403 as described below.

(3-2-4) Web Server Program 403

The web server program 403 provides an interface for receiving, via a network such as the LAN 101, a request for the MFP 100 to perform a process.

(3-2-5) Application Program 404

The application program 404 may be used, for example, in a case where image data, which was generated by the MFP 100 by scanning, is stored in a web server of a third vender and the file format is converted. The user interface of the application program 404 may be written in the C language as one example, but may be written in the HTML (Hyper Text Markup Language), in which case it can be written easily, with less time and effort.

(3-2-6) Device Drivers

The communication driver 420 controls the NIC 304 and the facsimile modem 305. The HDD driver 421 controls the HDD 303. The operation panel driver 422 controls the input/output of the operation panel 201, namely, the LCD 310, touch panel 311 and hard keys 312. The scanner driver 423 controls the seamier 210 to read a document and generate image data. The printer driver 424 controls the printer engine 202 to execute an image formation.

### [4] STRUCTURE OF APPLICATION SERVER 102

Next, the structure of the application server 102 is described. The application server 102, as a so-called web server, provides the MFPs 100 with application programs. Also, the application server 102 may register an application program with the MFP 100 by permission of the management terminal 103, as described below.

(4-1) Hardware Structure of Application Server 102

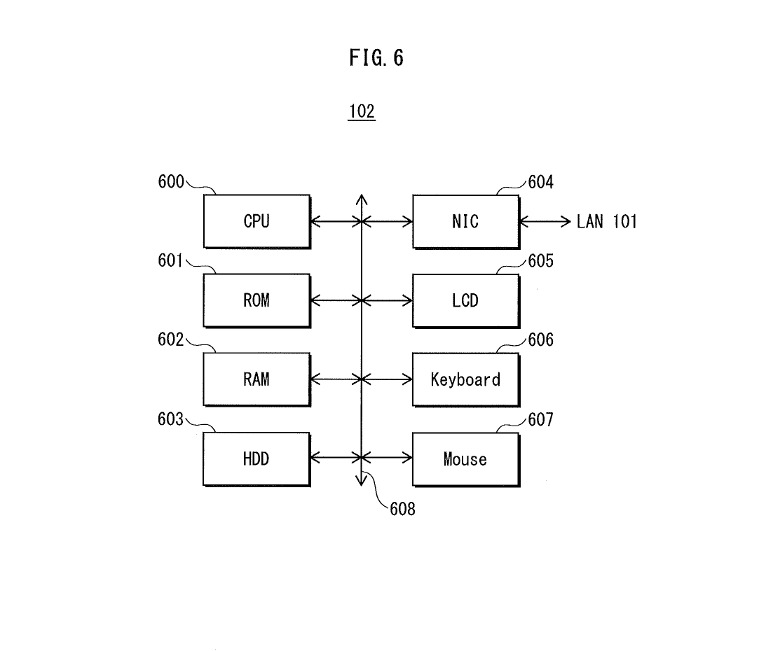

FIG. 6 is a diagram illustrating the main hardware structure of the application server 102. As illustrated in FIG. 6, the application server 102 includes a CPU 600, a ROM 601, a RAM 602, an HDD 603, an NIC 604, an LCD 605, a keyboard 606, and a mouse 607, which are connected with each other via an internal bus 608. When powered on, the CPU 600 reads a boot program from the ROM 601 and performs a hoot-up operation, then reads from the HDD 603 programs such as an OS and web server program, and operates by using the RAM 602 as a working storage area.

The NIC 604 is provided to perform communications with other devices via the LAN 101 or the Internet 110 under the control of the CPU 600, and executes, for example, the protocol processing of lower four layers in the OSI reference model.

The application server 102, as a web server, transmits web data via the LAN 101 and does not use the LCD 605, keyboard 606 and mouse 607 on a regular basis, but includes them for the purpose of maintenance management. The keyboard 606 and/or the mouse 607 may be connected via a USB (Universal Serial Bus).

(4-2) Software Structure of Application Server 102

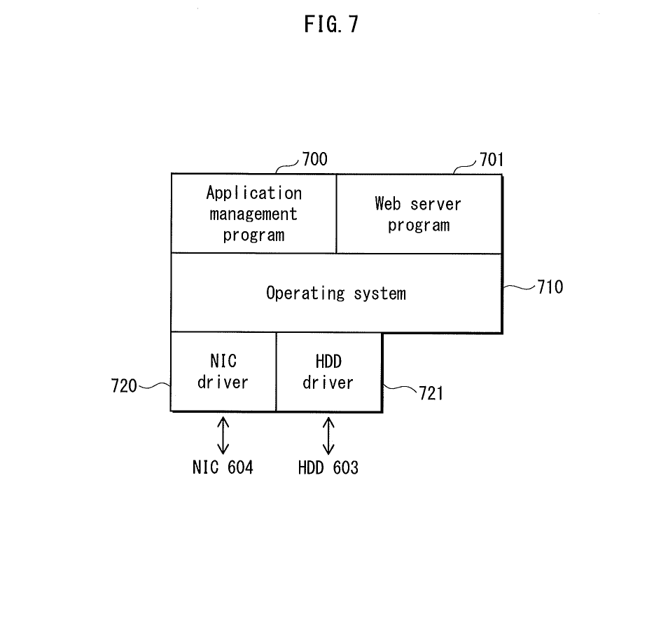

FIG. 7 is a diagram illustrating the main software structure of the application server 102. As illustrated in FIG. 7, the application server 102 is loaded with an operating system 710, and an application management program 700, a web server program 701 or the like is executed on the operating system 710. The operating system 710 includes an NIC driver 720, an HDD driver 721 and the like that are embedded therein as device drivers. The communication driver 720 controls the NIC 304, and the HDD driver 721 controls the HDD 303.

### [5] STRUCTURE OF MANAGEMENT TERMINAL 103

The management terminal 103 has approximately the same hardware and software structures as the application server 102. In the software structure, however, the management terminal 103 includes an application registration instruction program instead of the application management program 700, the application registration instruction program being used to instruct the application server 102 to register an application program. Also, the web server program 701 is not necessarily be indispensable, either.

### [6] OPERATION OF BROWSER SYSTEM 1

The following describes the operation of the browser system 1.

In the browser system 1, it is possible for the user of the MFP 100 to use an application program supplied from the application server 102, by using the browser program 400. To reduce the wait time for using the application program, the application server 102 registers the application program with the MFP 100.

(6-1) Registration of Application Program

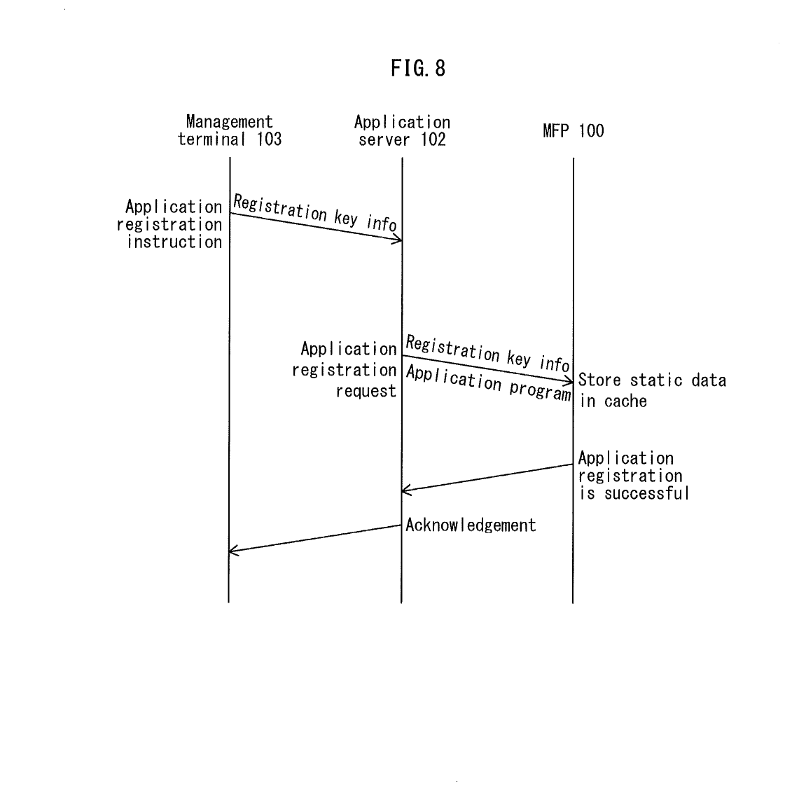

FIG. 8 is a sequence diagram illustrating the operation of the MFP 100, application server 102 and management terminal 103 in the browser system 1 for registering an application program with the MFP 100. As illustrated in FIG. 8, when an application program is registered with the MFP 100, first an application registration instruction is transmitted from the management terminal 103 to the application server 102. The application registration instruction is attached with registration key information that is to be used in the registration of the application program with the MFP 100.

Each application program is composed of one or more pieces of web data each of which corresponds to a URL. The web data constituting the application programs is classified into static data and dynamic data. The static data is data that is not changed except for at a version upgrade. Examples of the static data include image data, a JavaScript (registered trademark of Sun Microsystems Inc.) file, an icon, and a CSS (Cascading Style Sheets). The dynamic data is data other than the static data.

The application server 102, upon receiving an application registration instruction from the management terminal 103, first confirms that the registration key information, which is used in the registration of the application program with the MFP 100, is attached to the application registration instruction, and then requests registration of the application by transmitting the registration key information and the application program to the MFP 100.

The browser program 400 of the MFP 100 manages, on the HDD 303, a dedicated cache storage area and a general-purpose cache storage area as the cache storage areas for storing web data.

The web data (web pages) obtained from URLs that have been registered with the favorites are stored in the dedicated cache area so as not to be deleted, as described below. On the other hand, the web data obtained from URLs that have not been registered with the favorites are stored in the general-purpose cache area. In the general-purpose cache area, general cache processing is performed by using the LRU algorithm or the like depending on the storage capacity of the area, and detailed explanation thereof is omitted here.

Upon receiving the registration key information and the application program from the application server 102, the browser program 400 confirms the authenticity of the registration key information. When it confirms that the registration key information is authentic, the browser program 400 stores only the static data, among the data included in the application program, into the dedicated cache storage area. The dynamic data among the data of the application program is temporarily stored in a storage area on the RAM 302 (neither the dedicated cache storage area nor the general-purpose cache storage area).

Here, the specification of static data or dynamic data for each piece of web data may be performed by the application server 102. More specifically, when transmitting a piece of web data, the application server 102 may attach information indicating static data or dynamic data to the piece of web data, or may transmit separately a table that is a list of web data with indication of the data types.

Note that, when an application program is registered, it is preferable that the application server 102 transmits only static data among the web data constituting the application program, and only URLs among the dynamic data. This reduces the load imposed on the network and processing for transmitting the application programs.

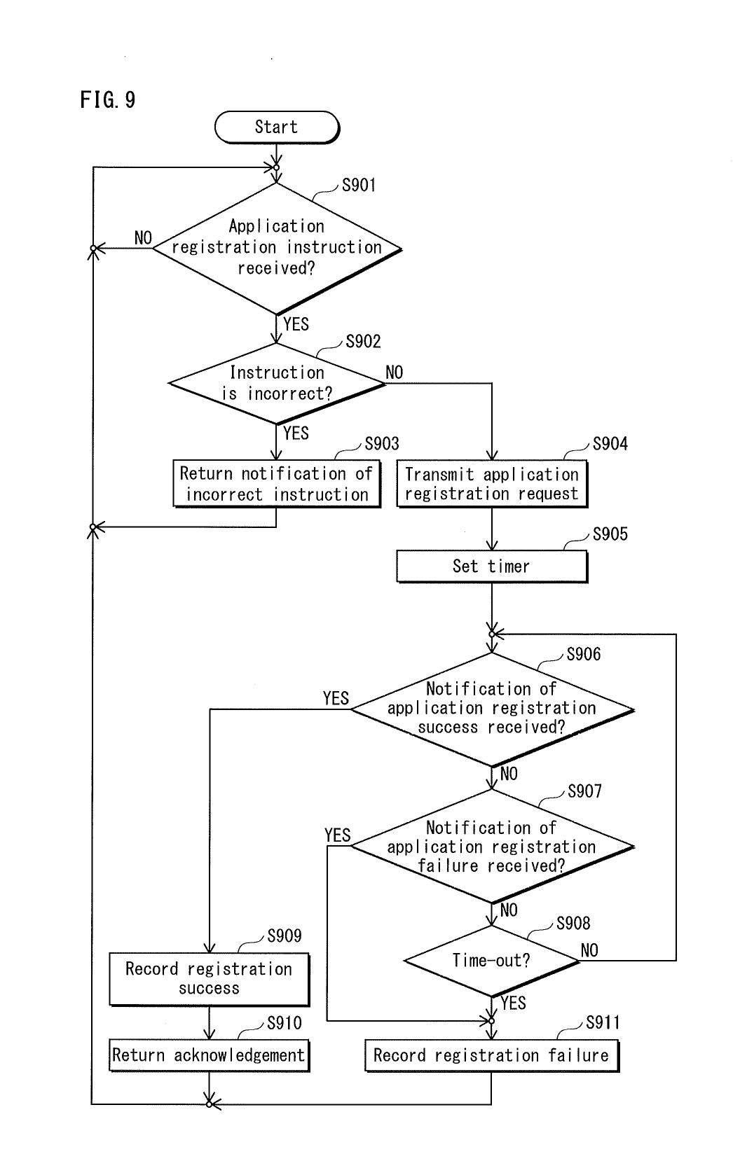

FIG. 9 is a flowchart illustrating the operation of the application management program 700. As illustrated in FIG. 9, the application management program 700, upon receiving an application registration instruction from the management terminal 103 (S901: YES), judges whether or not the application registration instruction is correct. In this case, it is checked on: whether or not the application registration instruction specifies an application program that is to be registered; whether or not the application registration instruction specifies an MFP 100 with which the application program is to be registered; and whether or not the application registration instruction includes registration key information that is to be used in the registration of the application program with the MFP 100. If any of these conditions is not satisfied, it is judged that the application registration instruction is incorrect. When it is judged that the application registration instruction is incorrect (S902: YES), a notification of an incorrect instruction is returned to the management terminal 103 (S903).

Here, the application management program 700 may, for example, accept the application registration instruction in accordance with the TCP (Transmission Control Protocol). In this case, the application management program 700, as a TCP server program identified by a predetermined port number, accepts opening of a TCP connection and then receives the application registration instruction. Opening and closing of a TCP connection are executed by a program of the management terminal 103 side.

When it judges that the application registration instruction is correct (S902: NO), the application management program 700 transmits an application registration request to an MFP 100 that is specified in the application registration instruction (S904). The application registration request is attached with the specified application program and the registration key information. Here, the TCP may be adopted, too. In that case, the MFP 100 side is assumed to be a TCP server, and the application management program 700, assumed to be a TCP client, requests opening of a TCP connection, specifying a predetermined port number. After this, when the TCP connection is established, the application management program 700 transmits the application registration request.

Subsequently, the application management program 700 sets a predetermined response monitor time in a timer (S905), then if it receives a notification of a registration success from the MFP 100 (S906: YES), it cuts off the TCP connection with the MFP 100, records, as log data, the registration success for this application registration instruction (S909), and returns an acknowledgement to the management terminal 103 (S910).

Also, when it receives from the MFP 100 a notification of an application registration failure (5907: YES), or when a time-out occurs with no response from the MFP 100 (S908: YES), the application management program 700 cuts off the TCP connection with the MFP 100, and records, as log data, the registration failure for this application registration instruction (S911).

The registration result recorded as log data may be notified in response to an inquiry from the management terminal 103. In that case, the application management program 700 may receive, for example, communication serial numbers as IDs (identifiers) of application registration instructions from the management terminal 103 and record the communication serial numbers as log data, and when it receives an inquiry with an ID of an application registration instruction from the management terminal 103, it may transmit a piece of log data corresponding to the received ID to the management terminal 103, as a response to the inquiry.

When it is judged that a time-out has not occurred (S908: NO), the control returns to step S906 to repeat the above-described processes. Also, after the processes of steps S910 and S911, the control returns to step S901 to repeat the above-described processes.

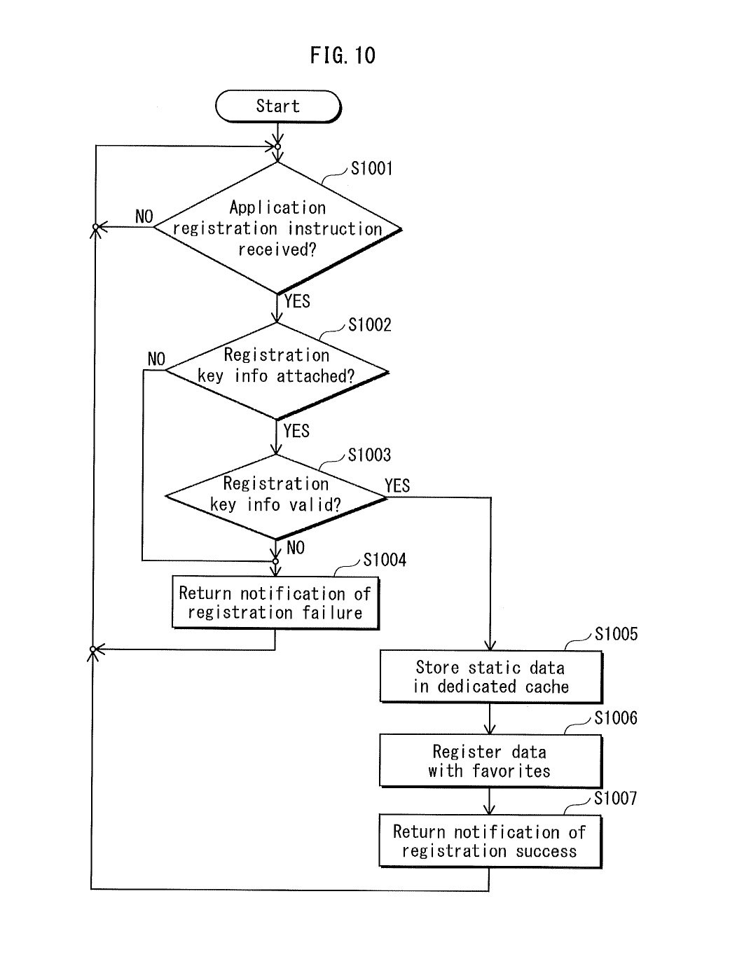

FIG. 10 is a flowchart illustrating the operation of the API program 401. As illustrated in FIG. 10, upon receiving an application registration instruction from the application server 102 (S1001: YES), the API program 401 judges whether or not the registration key information is attached to the application registration instruction. When it judges that the registration key information is attached to the application registration instruction (S1002: YES), the API program 401 performs an authentication process to check the validity of the registration key information. When it judges that the registration key information is not attached to the application registration instruction (S1002: NO), or when it judges that the registration key information is not valid (S1003: NO), the API program 401 returns a notification of application registration failure to the application server 102 (S1004).

As described above, the API program 401 may, as a TCP server, accept an application registration request. In that case, the API program 401, identified by a predetermined port number, accepts opening of a connection and then receives the application registration instruction.

When it judges that the registration key information is valid (S1003: YES), the API program 401 stores static data among the data constituting the received application program into the dedicated cache storage area (S1005), and registers it with the favorites (S1006). The registration of the application program with the favorites is made by storing favorite data, in which the static data or the URL among the dynamic data included in the application program is recorded, into a favorites storage area.

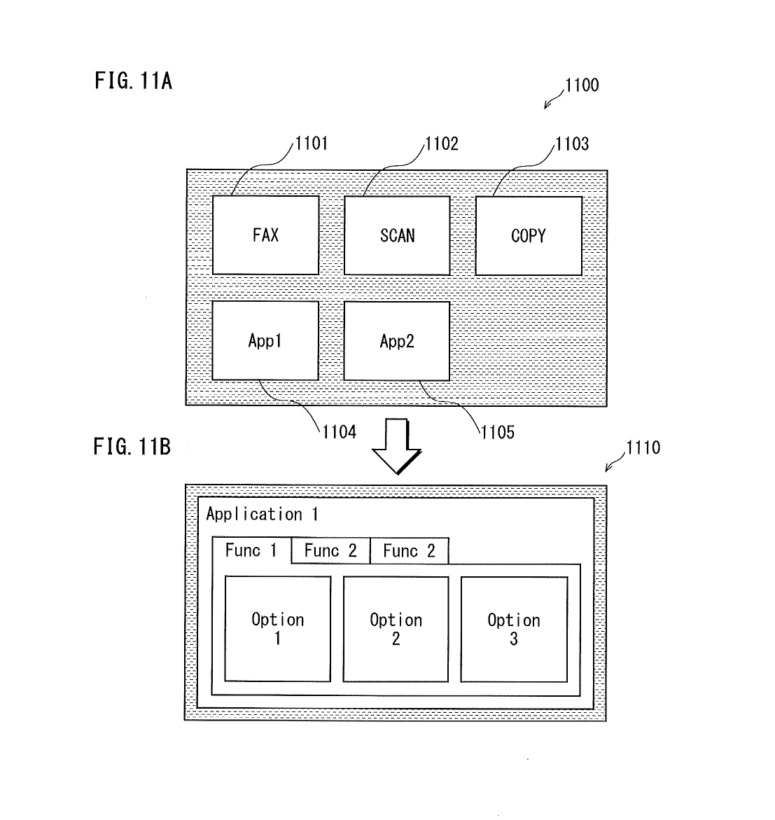

Note that, in the present embodiment, when an application program is registered with the favorites (namely, “a URL is registered”), a short cut key is displayed on the browser screen of the operation panel 201. This enables the user to activate the application program by touching the short cut key. FIGS. 11A and 11B are diagrams illustrating examples of the display screen of the operation panel 201: FIG. 11A illustrates the browser screen; and FIG. 11B illustrates the application screen.

As illustrated in FIG. 11A, on a browser screen 1100, short cut keys 1101-1103 for activating the original functions of the MFP 100 such as the FAX, scan and copy are displayed, as well as short cut keys 1104 and 1105 for activating application programs. The short cut keys 1104 and 1105 have been registered by the API program 401. Each short cut key for activating an application program is associated with favorite data of the application program.

For example, when the short cut key 1104 is touched, favorite data of application program 1 is referred to, and necessary static data or dynamic data is obtained, thereby the application program is activated, and the application screen 1110 is displayed. As illustrated in FIG. 11B, as one example, buttons for receiving an operation input by the user and activating an application program are displayed on the application screen 1110.

The API program 401 returns a notification of application registration success to the application server 102 (S1007), and the process ends.

(6-2) Activation of Application Program 404

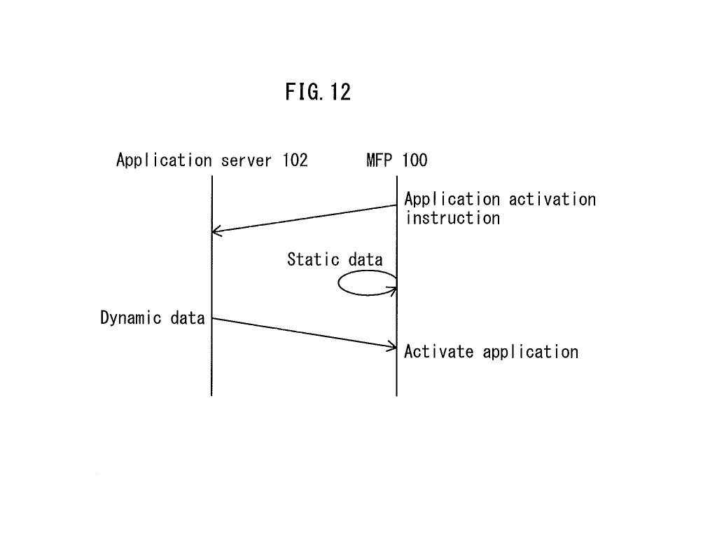

FIG. 12 is a sequence diagram illustrating the operation of the MFP 100 and application server 102 for the registered application program 404 to be activated by the user of the MFP 100. As illustrated in FIG. 12, when the user of the MFP 100 activates the application program 404 from the display screen of the browser program 400, the browser program 400 refers to the dedicated cache storage area, and if static data of the application program 404 is stored therein, obtains the static data. Also, with regard to the dynamic data, the browser program 400 requests the dynamic data from the web server program 701 of the application server 102 in accordance with the HTTP (Hyper Text Transfer Protocol). The web server program 701 sends the dynamic data in response to the request.

In the above example described with reference to FIGS. 8 to 10, when the application program 404 is registered with the MFP 100, static data pertaining to the application program 404 is stored in the dedicated cache area. However, not limited to this, if the static data is changed or increased after the storage, the difference data or the whole data of the static data after the change may be obtained and stored in the dedicated cache area again.

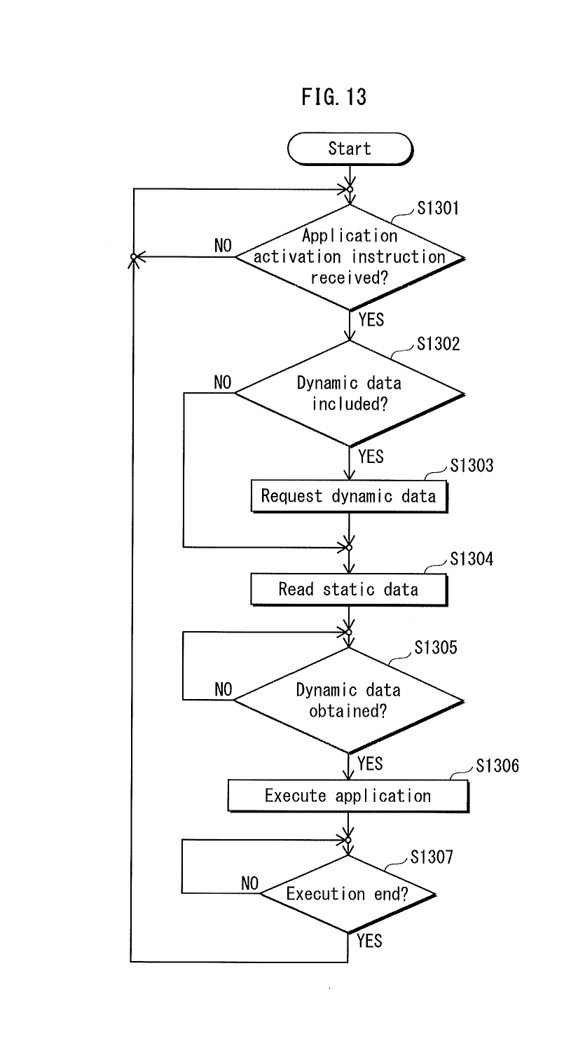

FIG. 13 is a flowchart illustrating the operation of the browser program 400 for activating the application program 404. As illustrated in FIG. 13, when instructed to activate the application program 404 by the user on the operation panel 201 (S1301: YES), the browser program 400 judges whether or not dynamic data is necessary to activate the application program 404.

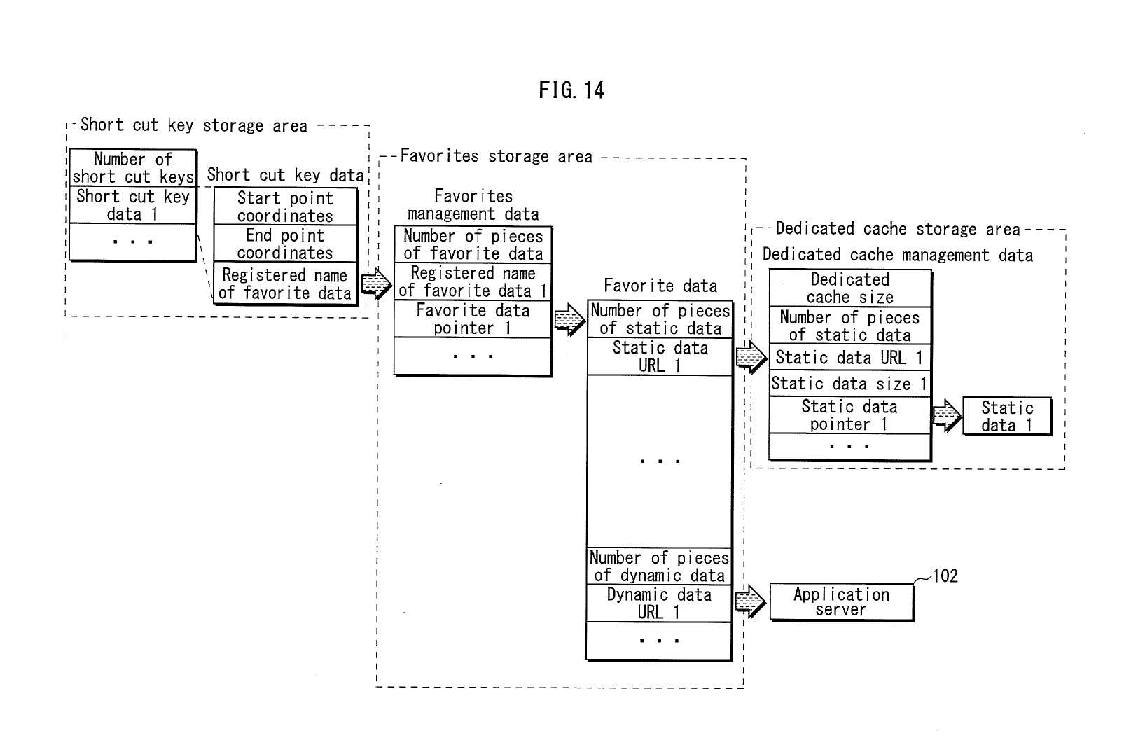

More specifically, as illustrated in FIG. 11B, when the user touches the short cut key 1104 or 1105 that is displayed on the browser screen 1100 as a short cut to an application program, the short cut key storage area is referred to, as illustrated in FIG. 14. The short cut key storage area stores information indicating the number of short cut keys (“number of short cut keys”), and short cut key data (“short cut key data”) for each of the short cut keys.

The “short cut key data” stores “start point coordinates (x1,y1)”, “end point coordinates (x2,y2)”, and “registered name of favorite data”, wherein the start and end point coordinates are respectively coordinates of the start point and end point of a short cut key that is in a rectangular shape displayed on the browser screen 1100, and the registered name of favorite data indicates the registered name of a piece of favorite data corresponding to a short cut key. Note that the “start point coordinates” and “end point coordinates” are each coordinates of an apex of a rectangular area (short cut key) satisfying x1<x2 and y1<y2.

When a touch of the screen by the user is detected, it is judged whether or not there is “short cut key data” that includes the coordinates (x,y) of the point touched by the user, between the “start point coordinates” and “end point coordinates” thereof. That is to say, it is judged whether or not there is “short cut key data” that satisfies x1≦x≦x2 and y1≦y≦y2. When there is “short cut key data” that satisfies these conditions, it is judged that a short cut key corresponding to the short cut key data was touched. In that case, as described in the following, a piece of favorite data having a “registered name of favorite data” that corresponds to the short cut key is referred to.

The favorites storage area stores favorites management data that is used for managing the favorite data. The favorites management data stores information indicating the number of pieces of favorite data stored in the favorites storage area (“number of pieces of favorite data”). Also, the favorites management data stores, for each piece of favorite data, one or more pairs of “registered name of favorite data” and “favorite data pointer”, wherein the “favorite data pointer” is the starting address of an area storing that piece of favorite data.

Each piece of favorite data stores “number of pieces of static data”, “static data URL”, “number of pieces of dynamic data”, and “dynamic data URL”, wherein the “number of pieces of static data” is information indicating the number of pieces of static data that are necessary to activate an application program corresponding to the touched short cut key, the “static data URL” is the URL of the piece of static data, the “number of pieces of dynamic data” is information indicating the number of pieces of dynamic data, and the “dynamic data URL” is the URL of the piece of dynamic data. Of these, with regard to the static data, a piece of static data identified by the “static data URL” is read from the dedicated cache storage area. Also, the dynamic data is obtained from the application server 102.

Note that the dedicated cache storage area stores, in addition to static data, dedicated cache management data for managing the static data. The dedicated cache management data stores “dedicated cache size”, “number of pieces of static data”, “static data URL”, “static data size”, and “static data pointer”, wherein the “dedicated cache size” indicates the size of the dedicated cache storage area, the “number of pieces of static data” indicates the number of pieces of static data stored in the dedicated cache storage area, the “static data URL” is the URL of the piece of static data, the “static data size” indicates the size of the piece of static data, and the “static data pointer” is the starting address of an area storing that piece of static data. To read a piece of static data from the dedicated cache storage area, first, the dedicated cache management data is searched for a “static data URL” that matches the “static data URL” stored in the favorite data. Subsequently, from a storage area indicated by a “static data pointer” corresponding to the “static data URL” that has been found by the searching, as much static data as indicated by the “static data size” are read, thereby the static data is obtained.

Meanwhile, when a delay time, which occurs when the dynamic data is obtained from the application server 102, is taken into account, it is preferable, in reducing the time for activating an application program, to obtain the dynamic data first and then the static data. Thus, as illustrated in FIG. 13, the browser program 400 first refers to the “number of pieces of dynamic data” in the favorite data, and judges whether or not the application program includes dynamic data. When it judges that the application program includes dynamic data (S1302: YES), the browser program 400 requests the dynamic data from the application server 102 (S1303). Of course, this request is made for each of all pieces of dynamic data included in the application program.

Subsequently, pieces of static data as indicated by the number of pieces of static data are read from the dedicated cache storage area (S1304). The static data has been stored in the dedicated cache storage area when the application program was registered. Thus if the short cut key for the application program has been registered, the static data can be read from the dedicated cache storage area without fail.

Next, the browser program 400 judges whether or not all pieces of dynamic data that were requested from the application server 102 have been received. When it judges that not all pieces of dynamic data have been received (S1305: NO), the browser program 400 waits for reception of a piece of dynamic data that has not been received yet. When it judges that all pieces of dynamic data have been received (S1305: YES), the browser program 400, judging that all necessary data have been obtained, executes the application program (S1306). When an end of the execution of the application program is confirmed (S1307: YES), the control returns to step S1301 to wait for the next instruction to activate an application program to be received.

With this structure, it is possible to read the static data from the dedicated cache storage area without fail, when an application program is activated. Thus, in contrast to conventional technologies, there is no fear that a cache-out of the static data from the cache memory occurs. This makes it possible to reduce the time for activating the application program, in a stable manner.

In the present embodiment, the static data is used to store data pertaining to a specific application server 102 that provides an application program related to a function of the MFP. Thus the application server 102, the number of application programs and contents thereof can be managed by the management terminal 103 or the like. Also, it is possible to manage or estimate the size of the static data that is to be stored into the dedicated cache storage area by each application program.

Since, as described above, the total size of the data to be stored in the dedicated cache storage area can be estimated in advance, a sufficient capacity is ensured for the dedicated cache storage area in advance to prevent a data overflow from occurring.

### [7] MODIFICATIONS

Up to now, the present invention has been described specifically through the embodiment. However, the present invention is not limited to the above-described embodiment, but may be modified variously as in the following.

(1) The above embodiment discloses reducing the time for activating a registered application program in a stable manner by using the dedicated cache storage area. However, the present invention is not limited to this structure. In addition to this, web pages, which have been registered with the favorites, may be stored in the dedicated cache storage area as well. This reduces the time for displaying a web page.

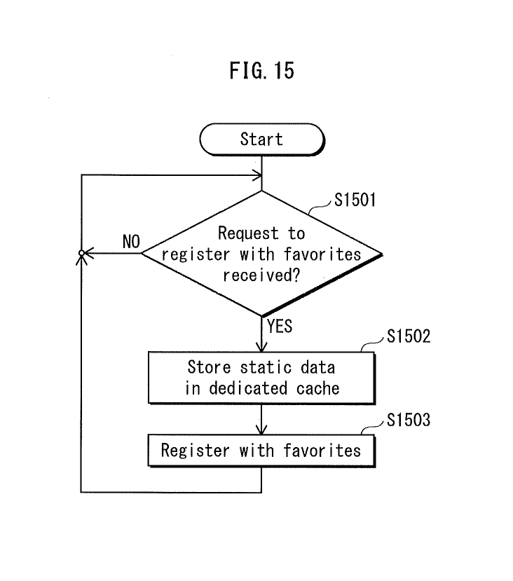

FIG. 15 is a flowchart illustrating the process of registering a web page with the favorites. As illustrated in FIG. 15, the browser program 400, upon receiving a request by the user to register a web page, which is currently displayed on the LCD 310 of the operation panel 201, with the favorites (S1501: YES), stores only static data among the web data of the web page into the dedicated cache storage area (S1502). The procedure for storing the static data into the dedicated cache storage area is the same as the procedure for storing the static data of the application program.

After the storage of the static data is completed, registration with the favorites is performed (S1504). More specifically, the value of the “number of pieces of favorite data” in the favorites management data stored in the favorites storage area is increased by one, the name, which is specified by the user when the user inputs the request to register the web page with the favorites, is stored as the “registered name of favorite data”, and the starting address of the new piece of favorite data is stored in the “favorite data pointer”. The new piece of favorite data stores “number of pieces of static data” and “static data URL” with regard to the static data, and “number of pieces of dynamic data” and “dynamic data URL” with regard to the dynamic data.

Subsequently, the control returns to step S1501 to repeat the above-described processes.

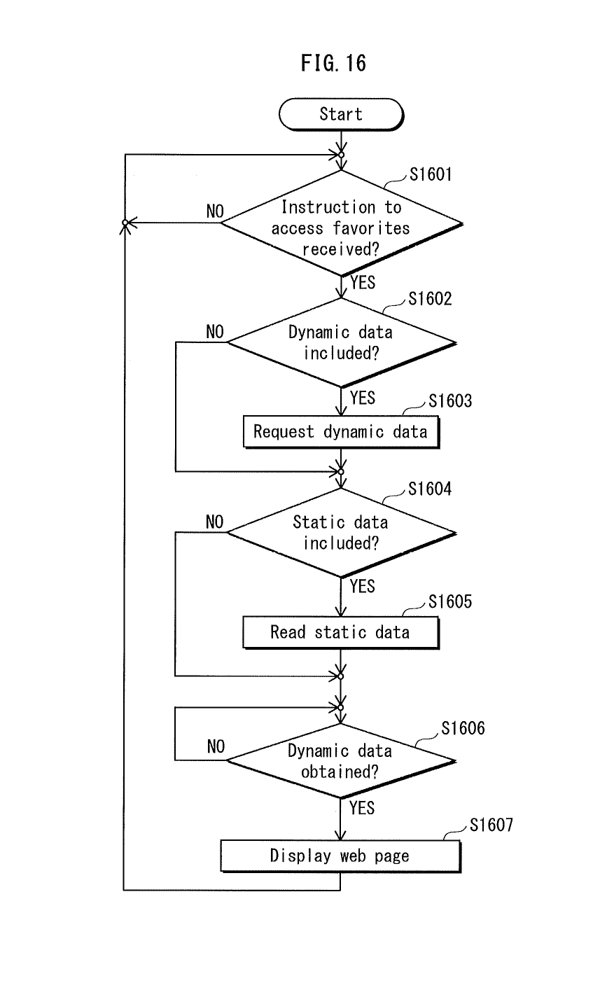

FIG. 16 is a flowchart illustrating the process of displaying a web page registered with the favorites. As illustrated in FIG. 16, the browser program 400, upon receiving an instruction to access a web page registered with the favorites (S1601: YES), refers to the favorites management data stored in the favorites storage area, reads “favorite data pointer” from the specified web page, and refers to the favorite data.

When the “number of pieces of dynamic data” in the favorite data is not 0, it is judged that the web page includes dynamic data (S1602: YES), and then the “dynamic data URL” in the dynamic data is used to request the web server 111 to transmit the dynamic data (S1603). When the “number of pieces of static data” in the favorite data is not 0, it is judged that the web page includes static data (S1604: YES), and then the static data is read from the dedicated cache storage area (S1605).

Subsequently, when all pieces of dynamic data that the web server 111 was requested to transmit are received (S1606: YES), the web page is displayed on the LCD 310, then the control returns to step S1601 and the above-described processes are repeated. Note that, when the dynamic data or static data received from the web server 111 is displayed on the LCD 310, the data may be displayed in the order of reception (first come, first displayed).

With the above structure, it is possible to reduce the time required for displaying the web page that has been registered with the favorites.

(2) The above modification describes the case where a web page registered with the favorites is displayed. Here, on the web data that is not registered with the favorites, the normal cache process may be performed.

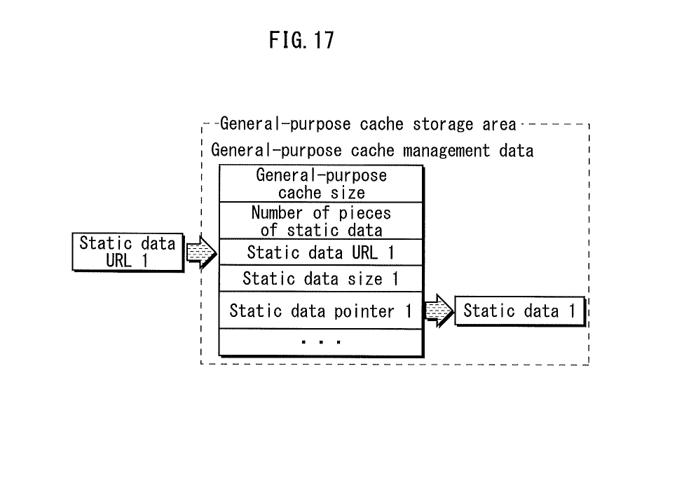

That is to say, when a web page not registered with the favorites is accessed as a result of an execution of a user instruction input via the operation panel 201, all the static data included in the web page may be stored in the general-purpose cache storage area. More specifically, as illustrated in FIG. 17, all pieces of static data are stored in the general-purpose cache storage area. Also, the URL and data size of each piece of static data, and the starting address of an area storing that piece of static data (static data pointer) are stored in the general-purpose cache management data, and the value of the “number of pieces of static data” in the general-purpose cache management data is increased by the number of pieces of static data that have been stored in the general-purpose cache storage area.

Note that, when the total of the “static data size” in the general-purpose cache management data exceeds “general-purpose cache size”, the static data is deleted in order from a piece with the oldest date of reference, so that a sufficient amount of free space to store a new piece of static data is created. When a piece of static data is deleted, the “static data URL”, “static data size”, and “static data pointer” corresponding to the deleted piece of static data are also deleted from the general-purpose cache management data, and the value of the “number of pieces of static data” is decreased by the number of pieces of static data that are deleted. After this, a new piece of static data is stored. The process for this is the same as that for storing a piece of static data in the dedicated cache storage area.

Furthermore, when a web page that has not been registered is to be accessed, it is checked whether or not static data pertaining to the web page is stored in the general-purpose cache storage area, and if it is confirmed that static data pertaining to the web page is stored in the general-purpose cache storage area, the web page is displayed by using the static data stored therein, without accessing the web server 111. Also, when it is confirmed that static data pertaining to the web page is not stored in the general-purpose cache storage area, the static data is obtained from the web server 111 by request.

With the above structure, it is possible to reduce the time required for obtaining the web page that has not been registered. This also applies to application programs that have not been registered.

(3) Although it is not particularly mentioned in the above embodiment, when the MFP 100 is shared by a plurality of users, it is desirable that the dedicated cache storage area is shared by the plurality of users, and the general-purpose cache storage area is provided separately for each of the plurality of users. This is because it is possible to prevent a cache-out of web data of a user due to an access of another user even if the plurality of users access different web pages. Note that the plurality of users are distinguished by, for example, the login names.

Also, in the case where a plurality of users are using the same MFP 100, it is possible to restrict the users independently to some of a plurality of functions supported by the MFP 100. Furthermore, it is possible to specify, for each user, whether or not the user can use an application program. Such specifications may be made by the management terminal 103 or the application server 102.

(4) In the above embodiment, the API program 401 accepts an application registration request. However, the present invention is not limited to this structure. For example, the browser program 400 may accept an application registration request.

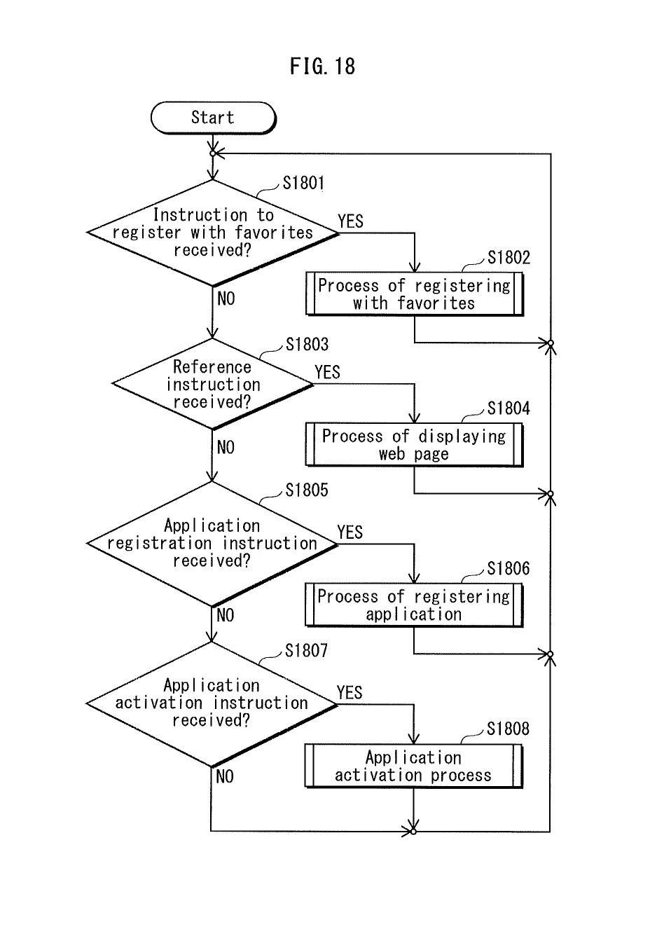

FIG. 18 is a flowchart illustrating the main operation of the browser program 400 in the present modification. As illustrated in FIG. 18, the browser program 400 in the present modification, upon receiving from the user an instruction to register a web page via the operation panel 201 (S1801: YES), executes the process of registering a web page with the favorites (S1802). The process of registering a web page with the favorites is the same as the process illustrated in FIG. 15.

Upon receiving an instruction to refer to the web page from the user of the MFP 100 on the operation panel 201 (S1803: YES), the browser program 400 obtains the web data from the specified URL, and executes the web page display process for displaying the web page on the operation panel 201 (S1804). Note that when the web page has been registered with the favorites, the web data is obtained as illustrated in FIG. 16.

Upon receiving an application registration instruction from the application server 102 (S1805: YES), the process of registering an application is executed (S1806). The process of registering an application is the same as the process illustrated in FIG. 10. Furthermore, when the operation panel 201 receives an application activation instruction (S1807: YES), the browser program 400 executes the application activation process (S1808). The application activation process is the same as the process illustrated in FIG. 13.

The present modification produces a similar effect to that of the above embodiment.

(5) The above embodiment explains a case where, when an application registration request sent from the application server 102 is accepted, web data pertaining to an application program is received from the application server 102 as well. However, the present invention is not limited to this structure. This structure may be replaced with the following as one example.

That is to say, the management terminal 103 may transmit the application registration instruction to the MFP 100, not to the application server 102; and the MFP 100 may return an acknowledgement to the management terminal 103 in response to the application registration instruction, and then may request the application server 102 to transmit an application program. Upon receiving the application program from the application server 102, the MFP 100 itself may execute the process of registering the application program with the MFP 100.

With the above-described structure, it is possible to reduce the amount of information pertaining to the MFP 100 that is transmitted from the management terminal 103 to the application server 102. This makes it possible to protect the security of the MFP 100 in a more reliable manner when the application server 102 is provided by a third vendor.

(6) Although it is not particularly mentioned in the above embodiment, in the case where the operating system 410 of the MFP 100 manages the file system on the HDD 303, a folder may be used as the dedicated cache storage arca (hereinafter the folder is referred to as a “dedicated cache folder”). In that case, a file storing the dedicated cache management data (hereinafter the file is referred to as a “dedicated cache management file”) is stored in the dedicated cache folder. Also, static data managed by the dedicated cache management file is stored in the dedicated cache folder as a file whose file name is the URL name thereof (hereinafter the file is referred to as a “static data file”).

Similarly, with regard to the general-purpose cache storage area, a general-purpose cache folder may be used in place of the general-purpose cache storage area, a general-purpose cache management file may be used in place of the general-purpose management data, and a static data file may be used in place of the static data.

Furthermore, with regard to the favorites storage area, similarly a favorites folder may be prepared, and a favorites management file may be used in place of the favorites management data. Also, the favorite data may be stored in the favorites folder, as a favorites file whose file name is the favorite data registration name.

(7) In the above embodiment, the case where the browser program 400 of the present invention is loaded in the MFP 100. However, the present invention is not limited to this case. For example, a similar effect to that of the above embodiment can be produced by applying the present invention to a single-function device such as a printer, a copier, or a facsimile machine, instead of a multi-function device. Furthermore, the advantageous effects of the present invention can be obtained regardless of whether the image forming apparatus is a multi-function device or a single-function device, or whether the apparatus is an apparatus supporting monochrome or color.

(8) The present invention may be a computer-readable recording medium storing a browser program of the present invention, or may be a non-transitory storage medium storing a browser program of the present invention. The above-mentioned recording medium and storage medium each include magnetic tape, a magnetic disk such as a flexible disk, an optical recording medium such as a DVD, CD-ROM, CD-R, MO, or PD, and a flash memory recording medium such as SmartMedia™ or Compact Flash™.

### [8] SUMMARY

The following is a summary of the characteristics of the present invention.

According to one aspect of the present invention, there is provided a browser device for obtaining web data of a specified URL, the browser device comprising: a registration unit configured to register one or more URLs; a dedicated cache memory configured to, when first web data is obtained from one of the one or more URLs registered, store the first web data without deleting existing web data that is stored already therein; a general-purpose cache memory configured to, when second web data is obtained from un unregistered URL, delete part or all of existing web data that is stored already in the general-purpose cache memory, in accordance with a capacity of the general-purpose cache memory, an amount of the existing web data that is stored already in the general-purpose cache memory, and an amount of the second web data, and then store the second web data; and an obtaining unit configured to, when the web data of the specified URL is stored in one of the dedicated cache memory and the general-purpose cache memory, obtain the web data therefrom, wherein the one or more URLs registered by the registration unit are in a range that allows for storage of web data in the dedicated cache memory.

With the above-described structure, the web data of the registered URL is stored in the dedicated cache memory, and once stored therein, the web data is not deleted therefrom. Thus a cache hit occurs every time the web data is used. This reduces in a stable manner the time required to obtain the web data. Furthermore, the web data of the unregistered URL is stored in the general-purpose cache memory. This reduces the time required to obtain the web data each time a cache hit occurs.

Accordingly, for example, web data, such as an application program, that is large in size, or web data, such as a web page registered with the so-called favorites, that is frequently accessed may be registered and stored in the dedicated cache memory. This reduces in a stable manner the time required to obtain the web data.

Also, when only frequently accessed web data is registered, and as a result, only not frequently accessed web data is stored in the general-purpose cache memory, it is difficult for the general-purpose cache memory to become full. This makes it difficult for unregistered web data to be deleted from the general-purpose cache memory, reducing the time required to obtain the web data as well.

In the above-described browser device, the registration unit may register a URL upon request received from another device via a network. In this browser device, the another device may be a web server from which web data of the registered URL is obtained. It should be noted here that the web server is required to perform the procedure of registering a URL with the browser device. In this respect, the web server is distinguished from a general web server.

In the above-described browser device, the dedicated cache memory may obtain the web data from the another device and store the web data therein when the URL is registered. With this structure, before the first activation of an application program, the web data of the application program is stored in the dedicated cache memory. This reduces in a stable manner the time required to activate the application program.

In the above-described browser device, the registration unit may include: an authentication unit configured to perform an authentication before accepting to register the URL requested by the another device; and a registration rejecting unit configured to reject registering the URL when the authentication of the another device results in failure. If the browser device unconditionally registers a URL upon request received from another device, a problem may occur in terms of the security management of the browser device. For example, web data containing a computer virus might be registered with the browser device. This taken into account, it is desirable for the browser device to perform an authentication before accepting to register a URL.

The above-described browser device may further comprise: a login receiving unit configured to receive logins of a plurality of users, wherein the registration unit may accept to register a URL in common with the plurality of users, and the dedicated cache memory may store web data in common with the plurality of users. With this structure, it is possible to save the storage area space of the browser device, compared with the case where the dedicated cache memory is provided separately for each of the plurality of users. Also, there is no need to store web data in each of the plurality of cache memories. Accordingly the structure also spares the time and effort for registering URLs.

In the above-described browser device, the general-purpose cache memory may be provided for each of the plurality of users. With this structure, different from the case where the general-purpose cache memory is provided in common with the plurality of users, it is possible to solve a problem that a cache-out of web data of a URL, which is intended to be accessed by a user, occurs due to an access of another user when the plurality of users of the browser device access different URLs.

In the above-described browser device, the dedicated cache memory may store only static data contained in the first web data, the static data not being updated sequentially. This is because dynamic data, which is updated sequentially, needs to be obtained each time the URL is accessed.

What is claimed is:

1. A browser device for obtaining web data of a specified URL, the browser device comprising:
a registration unit configured to register one or more URLs;
a dedicated cache memory configured to, when first web data is obtained from one of the one or more URLs registered, store the first web data without deleting existing web data that is stored already therein;
a general-purpose cache memory configured to, when second web data is obtained from un unregistered URL, delete part or all of existing web data that is stored already in the general-purpose cache memory, in accordance with a capacity of the general-purpose cache memory, an amount of the existing web data that is stored already in the general-purpose cache memory, and an amount of the second web data, and then store the second web data; and
an obtaining unit configured to, when the web data of the specified URL is stored in one of the dedicated cache memory and the general-purpose cache memory, obtain the web data therefrom, wherein
the one or more URLs registered by the registration unit are in a range that allows for storage of web data in the dedicated cache memory.

2. The browser device of claim 1, wherein
the registration unit registers a URL upon request received from another device via a network.

3. The browser device of claim 2, wherein
the another device is a web server from which web data of the registered URL is obtained.

4. The browser device of claim 2, wherein
the dedicated cache memory obtains the web data from the another device and stores the web data therein when the URL is registered.

5. The browser device of claim 2, wherein
the registration unit includes:
an authentication unit configured to perform an authentication before accepting to register the URL requested by the another device; and
a registration rejecting unit configured to reject registering the URL when the authentication of the another device results in failure.

6. The browser device of claim 1 further comprising:
a login receiving unit configured to receive logins of a plurality of users, wherein
the registration unit accepts to register a URL in common with the plurality of users, and
the dedicated cache memory stores web data in common with the plurality of users.

7. The browser device of claim 6, wherein
the general-purpose cache memory is provided for each of the plurality of users.

8. The browser device of claim 1, wherein
the dedicated cache memory stores only static data contained in the first web data, the static data not being updated sequentially.

9. An image forming apparatus comprising:
a browser device for obtaining web data of a specified URL, the browser device including:
a registration unit configured to register one or more URLs;
a dedicated cache memory configured to, when first web data is obtained from one of the one or more URLs registered, store the first web data without deleting existing web data that is stored already therein;
a general-purpose cache memory configured to, when second web data is obtained from un unregistered URL, delete part or all of existing web data that is stored already in the general-purpose cache memory, in accordance with a capacity of the general-purpose cache memory, an amount of the existing web data that is stored already in the general-purpose cache memory, and an amount of the second web data, and then store the second web data; and
an obtaining unit configured to, when the web data of the specified URL is stored in one of the dedicated cache memory and the general-purpose cache memory, obtain the web data therefrom, wherein
the registration unit registers a URL upon request received from another device via a network,
the another device is a server that provides, as web data, an application program pertaining to a function of the image forming apparatus, and
the registration unit registers a URL upon request received from the server.

10. A non-transitory storage medium storing a browser program for causing a computer, which includes a dedicated cache memory and a general-purpose cache memory, to obtain web data of a specified URL, the browser program causing the computer to execute:
a registration step of registering one or more URLs;
a dedicated cache memory storage step of, when first web data is obtained from one of the one or more URLs registered, storing the first web data in the dedicated cache memory without deleting existing web data that is stored already in the dedicated cache memory;
a general-purpose cache memory storage step of, when second web data is obtained from un unregistered URL, deleting part or all of existing web data that is stored already in the general-purpose cache memory, in accordance with a capacity of the general-purpose cache memory, an amount of the existing web data that is stored already in the general-purpose cache memory, and an amount of the second web data, and then store the second web data in the general-purpose cache memory; and
an obtaining step of, when the web data of the specified URL is stored in one of the dedicated cache memory and the general-purpose cache memory, obtaining the web data therefrom.

11. A browser system comprising a web server and a browser device that are connected via a network, the web server holding a plurality of pieces of web data, the browser device obtaining a piece of web data of a specified URL,
the browser device including:
a registration unit configured to register one or more URLs;
a dedicated cache memory configured to, when first web data is obtained from one of the one or more URLs registered, store the first web data without deleting existing web data that is stored already therein;
a general-purpose cache memory configured to, when second web data is obtained from un unregistered URL, delete part or all of existing web data that is stored already in the general-purpose cache memory, in accordance with a capacity of the general-purpose cache memory, an amount of the existing web data that is stored already in the general-purpose cache memory, and an amount of the second web data, and then store the second web data; and
an obtaining unit configured to, when the piece of web data of the specified URL, is stored in one of the dedicated cache memory and the general-purpose cache memory, obtain the web data therefrom, the web server including:
a registration requesting unit configured to request the browser device to register a URL.
